(19) United States
(12) Patent Application Publication
(10) Pub. No.: US 2026/0220742 A1
(43) Pub. Date: Jul. 30, 2026

(54) IMAGE PROCESSING METHOD AND APPARATUS, DEVICE AND MEDIUM

(71) Applicant: Beijing Zitiao Network Technology Co., Ltd., Beijing (CN)

(72) Inventor: Meng YAN, Beijing (CN)

(21) Appl. No.: 19/149,053

(22) PCT Filed: Jan. 3, 2024
(86) PCT No.: PCT/CN2024/070322

§ 371 Date: Jul. 17, 2025

(30) Foreign Application Priority Data
Jan. 18, 2023 (CN) 202310086534.X

(51) Int. Cl. G06T 5/30; G06T 5/50; G06T 5/70; G06T 7/13; G06T 7/40

(52) U.S. Cl. CPC G06T 5/30; G06T 5/50; G06T 5/70; G06T 7/13; G06T 7/40; G06T 2207/20221

(57) ABSTRACT

The present disclosure discloses an image processing method and apparatus, a device, and a medium. An image to be processed and a mask image corresponding to the image to be processed are obtained, the mask image is a mask image corresponding to a target object included in the image to be processed. The mask image is processed by using a first processing mode, to obtain a first mask image, and distortion processing is performed on the first mask image by using a second processing mode, to obtain a second mask image. The image to be processed is processed by using the first mask image and the second mask image, to obtain a target image, a first side of an edge of the target object exhibits a texture corresponding to the first mask image, and a second side of the edge exhibits a texture corresponding to the second mask image.

### CROSS-REFERENCE TO RELATED APPLICATION(S)

The present application claims priority to Chinese Patent Application No. 202310086534.X, filed on Jan. 18, 2023, and entitled “IMAGE PROCESSING METHOD AND APPARATUS, DEVICE, AND MEDIUM”, which is incorporated herein by reference in its entirety.

### FIELD

The present disclosure relates to the field of computer technologies, and in particular, to an image processing method and apparatus, a device, and a medium.

### BACKGROUND

With the continuous development of image processing technologies, users can process images according to their own needs to obtain images with certain effects. However, the current processing modes on images are relatively limited and cannot meet the diverse needs of the users.

### SUMMARY

In view of this, the present disclosure provides an image processing method and apparatus, a device, and a medium, to achieve diversified processing of images to meet user needs.

To achieve the above objective, the technical solutions provided by the present disclosure are as follows.

According to a first aspect, the present disclosure provides an image processing method. The method comprises: obtaining a mask image corresponding to an image to be processed, the image to be processed including a target object, and the mask image being a mask image corresponding to the target object; processing the mask image by using a first processing mode, to obtain a first mask image; processing the first mask image by using a second processing mode, to obtain a second mask image; and processing the image to be processed by using the first mask image and the second mask image, to obtain a target image, a first side of an edge of the target object in the target image exhibiting a texture corresponding to the first mask image, and a second side of the edge of the target object exhibiting a texture corresponding to the second mask image.

According to a second aspect, the present application provides an image processing apparatus. The apparatus comprises: an obtaining unit configured to obtain a mask image corresponding to an image to be processed, the image to be processed including a target object, and the mask image being a mask image corresponding to the target object; and a processing unit configured to process the mask image by using a first processing mode, to obtain a first mask image; the processing unit being further configured to process the first mask image by using a second processing mode, to obtain a second mask image; and the processing unit being configured to process the image to be processed by using the first mask image and the second mask image, to obtain a target image, a first side of an edge of the target object in the target image exhibiting a texture corresponding to the first mask image, and a second side of the edge of the target object exhibiting a texture corresponding to the second mask image.

According to a third aspect, the present disclosure provides an electronic device. The device includes a processor and a memory, where the memory is configured to store instructions or a computer program; and the processor is configured to execute the instructions or computer program in the memory to cause the electronic device to perform the method of the first aspect.

According to a fourth aspect, the present disclosure provides a computer-readable storage medium having instructions stored therein. The instructions, when run on a device, cause the device to perform the method of the first aspect.

According to a fifth aspect, the present disclosure provides a computer program product. The computer program product includes a computer program/instructions. The computer program/instructions, when executed by a processor, cause the method of the first aspect to be implemented.

### BRIEF DESCRIPTION OF THE DRAWINGS

In order to more clearly describe the technical solutions in the embodiments of the present disclosure or in the prior art, the accompanying drawings for describing the embodiments or the prior art will be briefly described below. Apparently, the accompanying drawings in the description below show merely some embodiments recited in the present disclosure, and those of ordinary skill in the art may still derive other accompanying drawings from these accompanying drawings without any creative efforts.

FIG. 1 is a flowchart of an image processing method according to an embodiment of the present disclosure;

FIG. 2a is a schematic diagram of obtaining a mask image according to an embodiment of the present disclosure;

FIG. 2b is a schematic diagram of obtaining a first mask image according to an embodiment of the present disclosure;

FIG. 2c is a schematic diagram of obtaining a second mask image according to an embodiment of the present disclosure;

FIG. 3a is a schematic diagram of a target image according to an embodiment of the present disclosure;

FIG. 3b is a diagram showing a distortion processing effect according to an embodiment of the present disclosure;

FIG. 3c is a schematic diagram of another target image according to an embodiment of the present disclosure;

FIG. 4 is a diagram of a structure of an image processing apparatus according to an embodiment of the present disclosure; and

FIG. 5 is a schematic diagram of a structure of an electronic device according to an embodiment of the present disclosure.

### DETAILED DESCRIPTION OF EMBODIMENTS

In order for persons skilled in the art to better understand the solutions of the present disclosure, the technical solutions in the embodiments of the present disclosure will be described below clearly and completely with reference to the accompanying drawings in the embodiments of the present disclosure. Apparently, the embodiments described are merely some rather than all of the embodiments of the present disclosure. All other embodiments obtained by those of ordinary skill in the art based on the embodiments of the present disclosure without any creative efforts shall fall within the scope of protection of the present disclosure.

In order to add diversified processing effects to an edge of a target object in an image, the present disclosure provides an image processing method. Specifically, a mask image corresponding to an image to be processed is obtained, the image to be processed includes a target object, and the mask image is a mask image corresponding to the target object. The mask image is processed by using a first processing mode, to obtain a first mask image, and the first mask image is processed by using a second processing mode, to obtain a second mask image. The image to be processed is processed by using the first mask image and the second mask image, to obtain a target image, different sides of the target object in the target image exhibit different textures. The texture corresponding to the first mask image and the texture corresponding to the second mask image may be different. Specifically, the edge of the target object in the target image exhibits a ripped paper outline effect.

The ripped paper outline effect means that after an image is processed, edge lines of an object (such as a person and an animal) in the processed image are similar to tearing paper, revealing an uneven edge. Compared with the flat feeling of the image before processing, adding a ripped paper effect design can make the image look more vivid, casual, and realistic.

It can be understood that before the use of the technical solutions in the embodiments of the present disclosure, the user shall be informed of the type, range of use, use scenarios, etc., of personal information involved in an appropriate manner in accordance with the relevant laws and regulations, and the authorization of the user shall be obtained.

For example, in response to reception of an active request from a user, prompt information is sent to the user to clearly inform the user that the requested operation will require access to and use of personal information of the user. As such, the user can independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining user authorization is only illustrative and does not constitute a limitation on the implementations of the present disclosure, and other manners that satisfy the relevant laws and regulations may also be applied in the implementations of the present disclosure.

To facilitate understanding of the technical solutions provided in the present disclosure, an expression transfer model training process in the present disclosure will be first described below.

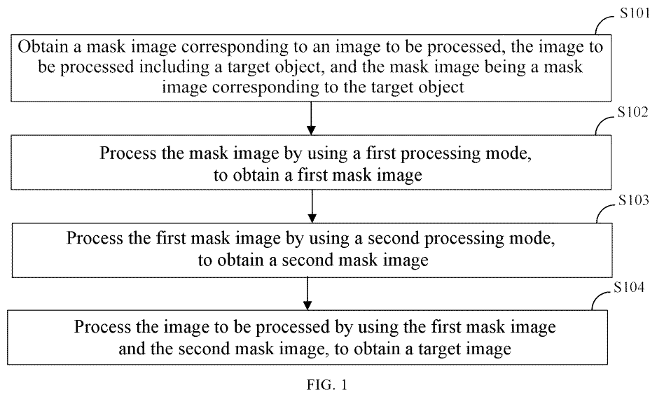

Reference is made to FIG. 1, which is a flowchart of an image processing method according to an embodiment of the present disclosure. The method may be performed by an image processing client, which may be incorporated in an electronic device. The electronic device may include devices with communication functions such as a mobile phone, a tablet computer, a notebook computer, a desktop computer, a vehicle-mounted terminal, a wearable electronic device, an all-in-one machine, and a smart home device, or a device simulated by a virtual machine or a simulator. As shown in FIG. 1, the method may include the following steps.

At S101, a mask image corresponding to an image to be processed is obtained.

The image to be processed includes a target object, and the mask image is a mask image corresponding to the target object. The target object may be a person, an animal, or another object. Specifically, mask processing may be performed on the image to be processed to obtain a mask image corresponding to the target object in the image to be processed. The mask image is a binary image composed of 0s and 1s. When a mask is applied, 1-value areas are processed and masked 0-value areas are not included in the calculation. The image mask is defined by specifying data values, data ranges, finite or infinite values, or regions of interest.

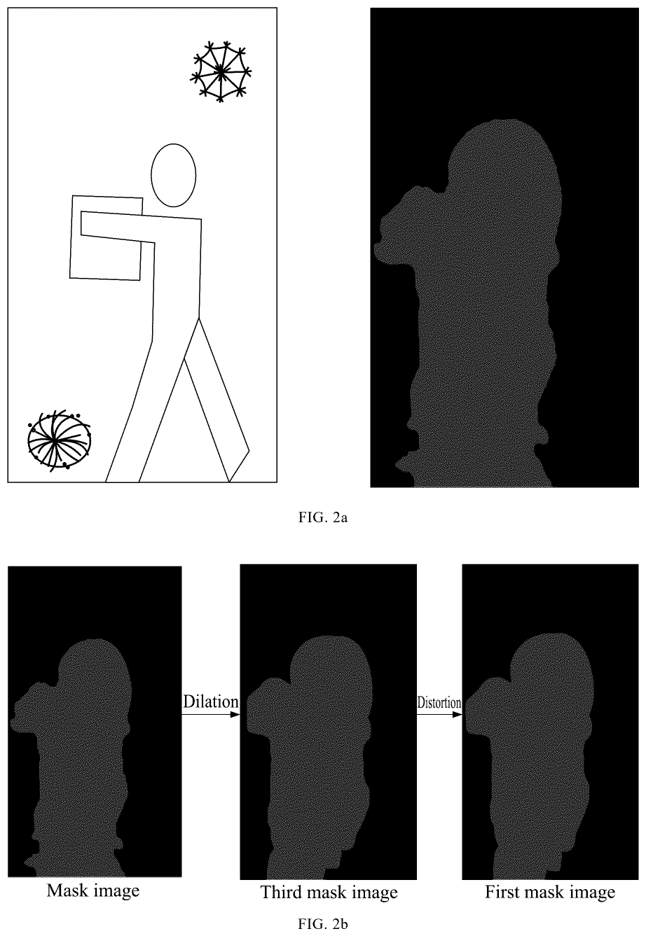

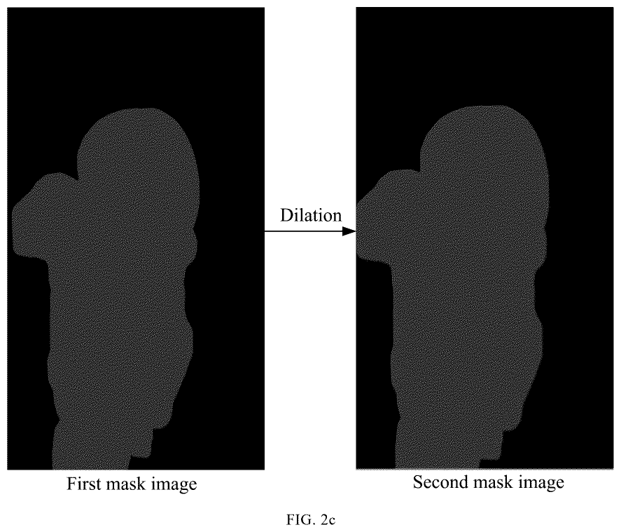

For example, as shown in FIG. 2a, the image to be processed includes a person and a plant, and mask processing is performed on the image to be processed to obtain a mask image corresponding to the person.

At S102, the mask image is processed by using a first processing mode, to obtain a first mask image.

The first processing mode may include dilation processing and/or distortion processing. The dilation processing refers to expanding and enlarging a bright white area in the image by adding pixels to the perceived boundary of an object in the image. The dilation processing of the image may be divided into three types: horizontal dilation, vertical dilation, and omnidirectional dilation, and in this embodiment mainly refers to omnidirectional dilation. For the distortion processing, the distortion of the image is to move a pixel from its original position to a new position according to a certain mapping.

In some implementations, when the first processing mode is the dilation processing, the dilation processing is performed on the mask image to obtain the first mask image; when the first processing mode is the distortion processing, the distortion processing is performed on the mask image to obtain the first mask image; and when the first processing mode includes the dilation processing and the distortion processing, the dilation processing may be first performed on the mask image to obtain a third mask image, and the distortion processing is then performed on the third mask image to obtain the first mask image. For example, a schematic diagram of masks corresponding to the first processing process is shown in FIG. 2b.

Specifically, the distortion processing may be performed on the third mask image to obtain the first mask image by: obtaining two value noise maps including a horizontal permutation map and a vertical permutation map; and performing horizontal permutation and vertical permutation on the third mask image by using the two value noise maps, to obtain the first mask image. Several vertices are defined in the value noise and each vertex contains a random value. These vertices will affect the surrounding coordinates based on their own random values. The closer to the vertex, the easier it is to be affected by the vertex. That is, in this embodiment, the first mask image is obtained by using the value noise maps to affect a horizontal direction and a vertical direction of the third mask image.

At S103, the first mask image is processed by using a second processing mode, to obtain a second mask image.

The second processing mode may include dilation processing or distortion processing. Specifically, when the second processing mode is the dilation processing, the dilation processing is performed on the first mask image to obtain the second mask image; and when the second processing mode is the distortion processing, the distortion processing is performed on the first mask image to obtain the second mask image. For example, a schematic diagram of the second mask image obtained after the dilation processing is performed on the first mask image is shown in FIG. 2c.

At S104, the image to be processed is processed by using the first mask image and the second mask image, to obtain a target image.

After the first mask image and the second mask image are obtained, the image to be processed is processed by using the first mask image and the second mask image, to obtain the target image. A first side of an edge of the target object in the target image exhibits a texture corresponding to the first mask image, and a second side of the edge of the target object exhibits a texture corresponding to the second mask image. The first side may be an inner side of the edge of the target object, or an outer side of the edge of the target object. When the first side is the inner side of the edge of the target object, the second side is the outer side of the edge of the target object; and when the first side is the outer side of the edge of the target object, the second side is the inner side of the edge of the target object. Specifically, the edge corresponding to the target exhibits a ripped paper outline effect.

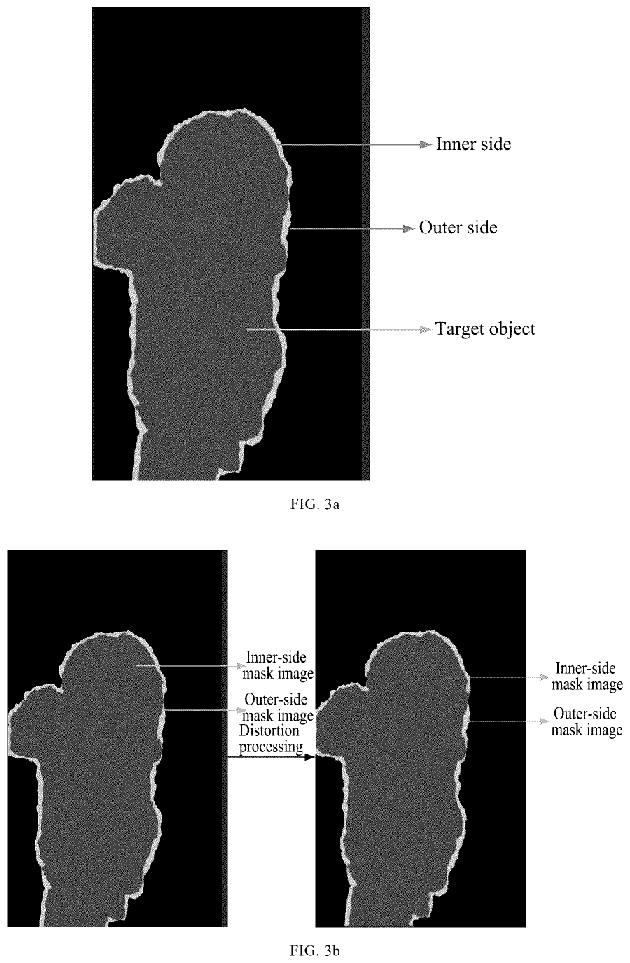

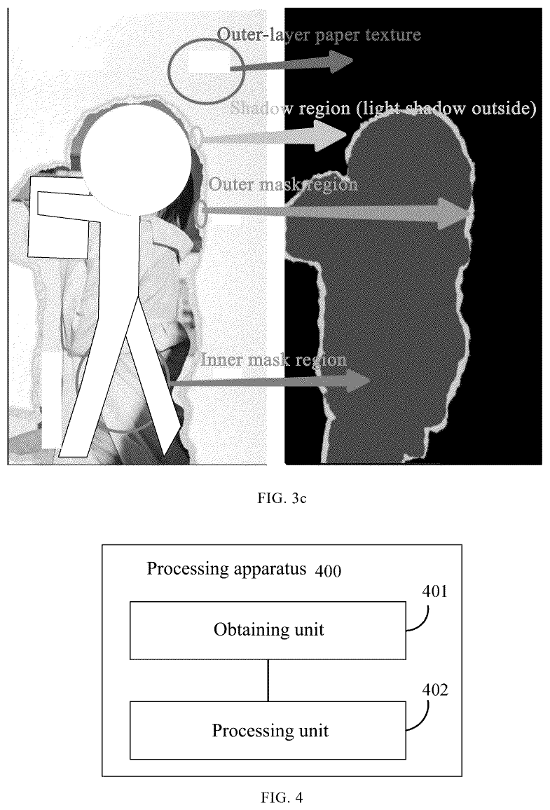

Specifically, the first mask image and the second mask image are used to perform combined processing on the image to be processed to obtain the target image. For example, in the schematic diagram shown in FIG. 3a, the first mask image and the second mask image are combined together to process the image to be processed. In response to the first side being the inner side, the target object is filled in the first mask image, and the inner side of the edge of the target object is the texture corresponding to an edge of the first mask image, and the outer side of the edge of the target object is the texture corresponding to the edge of the first mask image.

It can be seen that the image to be processed and the mask image corresponding to the image to be processed are obtained, the mask image is a mask image corresponding to the target object included in the image to be processed. The mask image is processed by using the first processing mode, to obtain the first mask image, and distortion processing is performed on the first mask image by using the second processing mode, to obtain the second mask image. The image to be processed is processed by using the first mask image and the second mask image, to obtain the target image, the first side of the edge of the target object in the target image exhibits a texture corresponding to the first mask image, and the second side of the edge of the target object exhibits a texture corresponding to the second mask image. Therefore, by the technical solutions provided by the present disclosure, it is possible to process the edge of the target object in the image to be processed, to allow different sides of the edge to exhibit different texture effects, thus improving the diversity of image processing.

In some implementations, before processing the image to be processed by using the first mask image and the second mask image, each of the first mask image and the second mask image may also be processed, and then the image to be processed is processed by using the processed first mask image and the processed second mask image, thereby enhancing the effect of image processing. Specifically, the distortion processing is performed on each of the first mask image and the second mask image to obtain a fourth mask image and a fifth mask image; and the image to be processed is processed by using the fourth mask image and the fifth mask image, to obtain the target image. The first side of the edge of the target object in the target image exhibits a texture corresponding to the fourth mask image, and the second side of the edge of the target object exhibits a texture corresponding to the fifth mask image.

Specifically, the distortion processing may be performed on the first mask image and the second mask image by: obtaining at least two fractal noise maps including a horizontal permutation map and a vertical permutation map; performing horizontal permutation and vertical permutation on the first mask image by using the at least two fractal noise maps, to obtain the fourth mask image; and performing horizontal permutation and vertical permutation on the second mask image by using the at least two fractal noise maps, to obtain the fifth mask image. Fractal noise is a detailed noise obtained by superimposing noises of different frequencies. When the first mask image is an inner-side mask image of the edge of the target object and the second mask image is an outer-side mask image of the edge of the target object, the fourth mask image is also an inner-inside mask image of the edge of the target object and the fifth mask image is an outer-side mask image of the edge of the target object.

In a specific implementation, in order to improve the diversity of processing results, four fractal noise maps may be obtained, and include two horizontal permutation maps and two vertical permutation maps. The horizontal permutation and vertical permutation are performed on the first mask image by using one of the horizontal permutation maps and one of the vertical permutation map, to obtain the fourth mask image. The horizontal permutation and vertical permutation are then performed on the second mask image by using the other horizontal permutation map and the other vertical permutation map, to obtain the fifth mask image.

In some implementations, to make the ripped paper effect exhibited at the edge more realistic, before processing the image to be processed by using the fourth mask image and the fifth mask image, the distortion processing is performed on the fourth mask image and the fifth mask image, and the image to be processed is processed by using the processed fourth mask image and the processed fifth mask image, to obtain the target image. Specifically, the distortion processing is performed on each of the fourth mask image and the fifth mask image to obtain a sixth mask image and a seventh mask image; and the image to be processed is processed by using the sixth mask image and the seventh mask image, to obtain the target image. The first side of the edge of the target object in the target image exhibits a texture corresponding to the sixth mask image, and the second side of the edge of the target object exhibits a texture corresponding to the seventh mask image. When the fourth mask image is an inner-side mask image of the edge of the target object and the fifth mask image is an outer-side mask image of the edge of the target object, the sixth mask image is also an inner-inside mask image of the edge of the target object and the seventh mask image is an outer-side mask image of the edge of the target object.

For example, FIG. 3b shows an effect diagram of the fourth mask image and the fifth mask image combined together on the left, and an effect diagram of the distortion-processed sixth mask image and seventh mask image combined together on the right. There are some fuzzy noises on the edges of the sixth and seventh mask images, which look more like fine fibers produced by tearing paper.

Specifically, the distortion processing may be performed on the fourth mask image and the fifth mask image by: obtaining at least two white noise maps including a horizontal permutation map and a vertical permutation map; performing horizontal permutation and vertical permutation on the fourth mask image by using the at least two white noise maps, to obtain the sixth mask image; and performing horizontal permutation and vertical permutation on the fifth mask image by using the at least two white noise maps, to obtain the seventh mask image.

In some implementations, in response to the second side being the outer side of the edge of the target object, before processing the image to be processed by using the first mask image and the second mask image, blur processing may further be performed on the second mask image to obtain a shadow mask image. Similarly, in response to the first side being the outer side of the target object, the blur processing may further be performed on the first mask image to obtain a shadow mask image. Then, the image to be processed is processed by using the first mask image, the second mask image and the shadow mask image, to obtain the target image. The outer side of the edge of the target object has a shadow region corresponding to the shadow mask image.

In some implementations, processing the image to be processed by using the inner first mask image, the second mask image and the shadow mask image, to obtain the target image includes: combining a paper texture and the image to be processed by using the inner first mask image, the second mask image and the shadow mask image, to obtain the target image. Other regions in the target image except an region where the target object is located have the paper texture.

For example, FIG. 3c shows a schematic diagram of a target image on the left, where an edge of a person in the target image exhibits a ripped paper outline effect.

Specifically, in response to the fourth mask image and the fifth mask image existing, the blur processing may be performed on the outer-side one of the fourth mask image and the fifth mask image to obtain a shadow mask image. Then, the image to be processed is processed by using the fourth mask image, the fifth mask image and the shadow mask image, to obtain the target image. Alternatively, in response to the sixth mask image and the seventh mask image existing, the blur processing may further be performed on the outer-side one of the sixth mask image and the seventh mask image to obtain a shadow mask image. Then, the image to be processed is processed by using the sixth mask image, the seventh mask image and the shadow mask image, to obtain the target image.

Based on the above method embodiment, the embodiments of the present application provide an image processing apparatus and an electronic device, which will be described below in conjunction with the accompanying drawings.

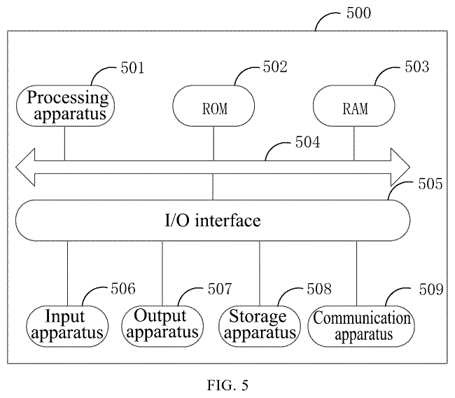

Reference is made to FIG. 4, which is a structural diagram of an image processing apparatus according to an embodiment of the present application. As shown in FIG. 4, the apparatus 400 includes an obtaining unit 401 and a processing unit 402.

The obtaining unit 401 is configured to obtain a mask image corresponding to an image to be processed, the image to be processed includes a target object, and the mask image is a mask image corresponding to the target object.

The processing unit 402 is configured to process the mask image by using a first processing mode, to obtain a first mask image.

The processing unit 402 is further configured to process the first mask image by using a second processing mode, to obtain a second mask image.

The processing unit 403 is configured to process the image to be processed by using the first mask image and the second mask image, to obtain a target image, a first side of an edge of the target object in the target image exhibits a texture corresponding to the first mask image, and a second side of the edge of the target object exhibits a texture corresponding to the second mask image.

In some implementations, the first processing mode includes dilation processing and/or distortion processing.

In some implementations, the processing unit 402 is specifically configured to: perform the dilation processing on the mask image to obtain a third mask image; and perform the distortion processing on the third mask image to obtain the first mask image.

In some implementations, the processing unit 402 is specifically configured to perform the dilation processing on the first mask image to obtain the second mask image.

In some implementations, the processing unit 402 is further configured to, before processing the image to be processed by using the first mask image and the second mask image, perform the distortion processing on each of the first mask image the second mask image to obtain a fourth mask image and a fifth mask image.

The processing unit 402 is specifically configured to process the image to be processed by using the fourth mask image and the fifth mask image, to obtain the target image, the first side of the edge of the target object in the target image exhibits a texture corresponding to the fourth mask image, and the second side of the edge of the target object exhibits a texture corresponding to the fifth mask image.

In some implementations, the processing unit 402 is configured to, before processing the image to be processed by using the fourth mask image and the fifth mask image, perform the distortion processing on each of the fourth mask image and the fifth mask image to obtain a sixth mask image and a seventh mask image.

The processing unit 402 is specifically configured to process the image to be processed by using the sixth mask image and the seventh mask image, to obtain the target image, the first side of the edge of the target object in the target image exhibits a texture corresponding to the sixth mask image, and the second side of the edge of the target object exhibits a texture corresponding to the seventh mask image.

In some implementations, in response to the second side being the outer side of the edge of the target object, the processing unit 402 is further configured to, before processing the image to be processed by using the first mask image and the second mask image, perform blur processing on the second mask image to obtain a shadow mask image.

The processing unit 402 is specifically configured to process the image to be processed by using the first mask image, the second mask image and the shadow mask image, to obtain the target image, the second side of the edge of the target object has a shadow region corresponding to the shadow mask image.

In some implementations, the processing unit 402 is specifically configured to combine a paper texture and the image to be processed by using the first mask image, the second mask image and the shadow mask image, to obtain the target image.

In some implementations, other regions in the target image except an region where the target object is located have the paper texture.

In some implementations, the processing unit 402 is specifically configured to: obtain two value noise maps including a horizontal permutation map and a vertical permutation map; and perform horizontal permutation and vertical permutation on the third mask image by using the two value noise maps, to obtain the first mask image.

In some implementations, the processing unit 402 is specifically configured to: obtain at least two fractal noise maps including a horizontal permutation map and a vertical permutation map; perform horizontal permutation and vertical permutation on the first mask image by using the at least two fractal noise maps, to obtain the fourth mask image; and perform horizontal permutation and vertical permutation on the second mask image by using the at least two fractal noise maps, to obtain the fifth mask image.

In some implementations, the processing unit 402 is specifically configured to: obtain at least two white noise maps including a horizontal permutation map and a vertical permutation map; perform horizontal permutation and vertical permutation on the fourth mask image by using the at least two white noise maps, to obtain the sixth mask image; and perform horizontal permutation and vertical permutation on the fifth mask image by using the at least two white noise maps, to obtain the seventh mask image.

In some implementations, the edge of the target object exhibits a ripped paper effect.

It should be noted that, for specific implementation of the various units in the embodiments, reference may be made to the related description in the above method embodiment. The division of units in the embodiments of the present disclosure is illustrative and is merely logical function division, and there may be other division methods in actual implementation. Various functional units in the embodiments of the present disclosure may be integrated into one processing unit, each of the units may exist alone physically, or two or more units may be integrated into one unit. For example, in the above embodiment, a processing unit and a sending unit may be the same unit or different units. The integrated unit may be implemented in the form of hardware, or may be implemented in the form of a software function unit.

Reference is made to FIG. 5, which is a schematic diagram of an electronic device 500 suitable for implementing an embodiment of the present disclosure. The terminal device in this embodiment of the present disclosure may include, but is not limited to, a mobile terminal such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal); and a fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 500 may include a processing apparatus (e.g., a central processor, a graphics processor, etc.) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the apparatuses shown. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, installed from the storage apparatus 508, or installed from the ROM 502. When the computer program is executed by the processing apparatus 501, the above-mentioned functions defined in the method of the embodiment of the present disclosure are performed.

The electronic device according to this embodiment of the present disclosure and the method according to the above embodiment belong to the same inventive concept. For the technical details not exhaustively described in this embodiment, reference may be made to the above embodiment, and this embodiment and the above embodiment have the same beneficial effects.

An embodiment of the present disclosure provides a computer storage medium having a computer program therein, where the program, when executed by a processor, implements the method according to the above embodiment.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future-developed network protocol such as a Hypertext Transfer Protocol (HTTP), and may be connected to digital data communication (for example, communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the above method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments shown herein, but extends to the widest scope that complies with the principles and novelty disclosed in this specification.

1. An image processing method, comprising:
obtaining a mask image corresponding to a first image, the first image comprising an object, and the mask image being a mask image corresponding to the object;
processing the mask image by using a first processing mode, to obtain a first mask image;
processing the first mask image by using a second processing mode, to obtain a second mask image; and
processing the first image by using the first mask image and the second mask image, to obtain a second image, a first side of an edge of the object in the second image exhibiting a texture corresponding to the first mask image, and a second side of the edge of the object exhibiting a texture corresponding to the second mask image.

2. The method according to claim 1, wherein the first processing mode comprises dilation processing and/or distortion processing.

3. The method according to claim 2, wherein processing the mask image by using the first processing mode, to obtain the first mask image comprises:
performing the dilation processing on the mask image to obtain a third mask image; and
performing the distortion processing on the third mask image to obtain the first mask image.

4. The method according to claim 1, wherein processing the first mask image by using the second processing mode, to obtain the second mask image comprises:
performing dilation processing on the first mask image to obtain the second mask image.

5. The method according to claim 1, wherein, before processing the first image by using the first mask image and the second mask image, the method further comprises:
performing distortion processing on each of the first mask image and the second mask image to obtain a fourth mask image and a fifth mask image; and
processing the first image by using the first mask image and the second mask image, to obtain the second image comprises:
processing the first image by using the fourth mask image and the fifth mask image, to obtain the second image, the first side of the edge of the object in the second image exhibiting a texture corresponding to the fourth mask image, and the second side of the edge of the object exhibiting a texture corresponding to the fifth mask image.

6. The method according to claim 5, wherein, before processing the first image by using the fourth mask image and the fifth mask image, the method further comprises:
performing the distortion processing on each of the fourth mask image and the fifth mask image to obtain a sixth mask image and a seventh mask image; and
processing the first image by using the fourth mask image and the fifth mask image, to obtain the second image comprises:
processing the first image by using the sixth mask image and the seventh mask image, to obtain the second image, the first side of the edge of the object in the second image exhibiting a texture corresponding to the sixth mask image, and the second side of the edge of the object exhibiting a texture corresponding to the seventh mask image.

7. The method according to claim 1, wherein, in response to the second side being an outer side of the edge of the object, before processing the first image by using the first mask image and the second mask image, the method further comprises:
performing blur processing on the second mask image to obtain a shadow mask image; and
processing the first image by using the first mask image and the second mask image, to obtain the second image comprises:
processing the first image by using the first mask image, the second mask image, and the shadow mask image, to obtain the second image, the second side of the edge of the object having a shadow region corresponding to the shadow mask image.

8. The method according to claim 7, wherein processing the first image by using the first mask image, the second mask image, and the shadow mask image, to obtain the second image comprises:
combining a paper texture and the first image by using the first mask image, the second mask image, and the shadow mask image, to obtain the second image.

9. The method according to claim 8, wherein other regions in the second image except a region where the object is located have the paper texture.

10. The method according to claim 1, wherein the edge of the object exhibits a ripped paper outline effect.

11. (canceled)

12. An electronic device, comprising a processor and a memory, wherein
the memory is configured to store instructions or a computer program; and
the processor is configured to execute the instructions or computer program in the memory to cause the electronic device to perform actions, the actions comprising:
obtaining a mask image corresponding to a first image, the first image comprising an object, and the mask image being a mask image corresponding to the object;
processing the mask image by using a first processing mode, to obtain a first mask image;
processing the first mask image by using a second processing mode, to obtain a second mask image; and
processing the first image by using the first mask image and the second mask image, to obtain a second image, a first side of an edge of the object in the second image exhibiting a texture corresponding to the first mask image, and a second side of the edge of the object exhibiting a texture corresponding to the second mask image.

13. The device according to claim 12, wherein the first processing mode comprises dilation processing and/or distortion processing.

14. The device according to claim 13, wherein processing the mask image by using the first processing mode, to obtain the first mask image comprises:
performing the dilation processing on the mask image to obtain a third mask image; and
performing the distortion processing on the third mask image to obtain the first mask image.

15. The device according to claim 12, wherein processing the first mask image by using the second processing mode, to obtain the second mask image comprises:
performing dilation processing on the first mask image to obtain the second mask image.

16. The device according to claim 12, wherein, before processing the first image by using the first mask image and the second mask image, the actions further comprise:
performing distortion processing on each of the first mask image and the second mask image to obtain a fourth mask image and a fifth mask image; and
processing the first image by using the first mask image and the second mask image, to obtain the second image comprises:
processing the first image by using the fourth mask image and the fifth mask image, to obtain the second image, the first side of the edge of the object in the second image exhibiting a texture corresponding to the fourth mask image, and the second side of the edge of the object exhibiting a texture corresponding to the fifth mask image.

17. The device according to claim 16, wherein, before processing the first image by using the fourth mask image and the fifth mask image, the actions further comprise:
performing the distortion processing on each of the fourth mask image and the fifth mask image to obtain a sixth mask image and a seventh mask image; and
processing the first image by using the fourth mask image and the fifth mask image, to obtain the second image comprises:
processing the first image by using the sixth mask image and the seventh mask image, to obtain the second image, the first side of the edge of the object in the second image exhibiting a texture corresponding to the sixth mask image, and the second side of the edge of the object exhibiting a texture corresponding to the seventh mask image.

18. The device according to claim 12, wherein, in response to the second side being an outer side of the edge of the object, before processing the first image by using the first mask image and the second mask image, the actions further comprise:
performing blur processing on the second mask image to obtain a shadow mask image; and
processing the first image by using the first mask image and the second mask image, to obtain the second image comprises:
processing the first image by using the first mask image, the second mask image, and the shadow mask image, to obtain the second image, the second side of the edge of the object having a shadow region corresponding to the shadow mask image.

19. The device according to claim 18, wherein processing the first image by using the first mask image, the second mask image and the shadow mask image, to obtain the second image comprises:
combining a paper texture and the first image by using the first mask image, the second mask image and the shadow mask image, to obtain the second image.

20. The device according to claim 19, wherein other regions in the second image except a region where the object is located have the paper texture.

21. (canceled)

22. A non-transitory computer-readable storage medium having instructions stored therein, wherein the instructions, when run on a device, cause the device to:
obtain a mask image corresponding to a first image, the first image comprising an object, and the mask image being a mask image corresponding to the object;
process the mask image by using a first processing mode, to obtain a first mask image;
process the first mask image by using a second processing mode, to obtain a second mask image; and
process the first image by using the first mask image and the second mask image, to obtain a second image, a first side of an edge of the object in the second image exhibiting a texture corresponding to the first mask image, and a second side of the edge of the object exhibiting a texture corresponding to the second mask image.
